(19) United States
(12) Patent Application Publication
(10) Pub. No.: US 2008/0278878 A1
(43) Pub. Date: Nov. 13, 2008

(54) Electronic Switch for Voltage Stabilization and Power Consumption Minimization

(75) Inventor: Sang Hee Shin, Seoul (KR)

Correspondence Address: THELEN LLP, P. O. BOX 640640, SAN JOSE, CA, 95164-0640, US

(73) Assignee: JOONGANG CONTROL CO., LTD., Goyang-City, Gyeonggi-Do (KR)

(21) Appl. No.: 11/547,384

(22) PCT Filed: Mar. 28, 2005
(86) PCT No.: PCT/KR2005/000898

§ 371 Date: Oct. 2, 2006

(30) Foreign Application Priority Data
Apr. 16, 2004 (KR) 20-2004-0010501
Nov. 30, 2004 (KR) 20-2004-0033825

(51) Int. Cl. H01H 47/00

(52) U.S. Cl. 361/208

(57) ABSTRACT

An electronic switch employing two input lines, but overcoming the problem in installation of the conventional 3-line electronic switch and the problem in power consumption and power stability of the conventional 2-line electronic switch. The switch comprises a) a power supply including a pair of diodes, each of which is inserted in series between the first and second lines, and both of which is connected parallel in the opposite polarity; a transformer for raising the voltage appearing across the diodes; a first rectifier for rectifying the raised AC into DC; a second rectifier for rectifying the current from the first line, when the first and second lines arc disconnected due to the lamp-off, b) a voltage regulator, including a means for suppressing abnormal rise in the output voltage of the voltage supply, and c) a relay drive including a relay which is operated by DC voltage from the voltage supply, whereby the relay is a self-holding relay that once activated by the current flowing the coil, the relay remains the activated state even though the voltage is removed.

### BACKGROUND OF THE INVENTION

1. Field of the Invention

The present invention relates to an electronic switch. More particularly the present invention relates to an electronic switch for having electric source for electric appliances obtained and for minimizing the power consumption.

2. Description of the Related Art

Switches for turning on and off lamps and electric appliances have been recently evolving into remote controls for convenience and safety, or electronic switches operated by electronic circuits.

Conventional 3-Line Electronic Switch

A conventional lamp switch has two terminals, in which if the terminals are connected, then the lamp turns on, and vice versa. On the other hand, an electronic switch for lamp use is built by a relay and SCR or a triac. A typical schematic of the electronic switch is shown in FIG. 1. A control 10 is for controlling and driving a relay RY1. The control 10 may be constructed to automatically turn the lamps on in the morning by the help of a built-in clock, or to automatically turn the lamps off at one's bedtime.

A power supply 12 is needed to get electric power for operating the control 10. Therefore, circuit in FIG. 1 is a circuit that utilizes commercial alternate current source for the control 10. The electric circuit in Fig. is called as “3-line electronic switch” since it has three input and output terminals, L1, L2, L3.

The advantages of this type electronic switch is that the power supply 12 supplies electric power to the control 10 stably irrespective of the amount of load. In addition, although power consumption in the control 10 is somewhat large, the stable power suppliance is possible. However, since it has three input and output terminals, it is inconvenient to replace the existing common switch.

Conventional 2-Line Electronic Switch

2-line switch shown in FIG. 2 has been developed for the purpose of easier replacement of the existing switch. Because of 2-line terminals, when a relay RY2 is turned on, the current flows through a resistor R1, and then electrical source necessary to a control 10 is obtained from this resistor R1. However, in such a switch circuit, if the relay RY2 is turned off, the current does not flow the resistor R1. So, it is necessary to build additional circuit to obtain electrical energy. For this, the circuit is constructed such that, when the switch is turned off, the current passing through C2 flows through the lamp L after passing through the power supply 12. Therefore, this type of electronic switch has disadvantage that the amount of electrical energy necessary to sufficiently drive the control 10 is limited. In addition, since the load of the lamp varies due to the voltage drop across the resistor R1, excessive heat is generated. Also, due to the low voltage drop, the operating current becomes insufficient.

### SUMMARY OF THE INVENTION

The present invention provides an electronic switch employing two input lines, but overcoming the problem in installation of the conventional 3-line electronic switch and the problem in power consumption and power stability of the conventional 2-line electronic switch.

According to an aspect of the present invention, there is provided an electronic switch for turning on an off a lamp, of which the both ends are connected between a first line and a second line, the electronic switch comprising: a) a power supply including a pair of diodes, each of which is inserted in series between the first and second lines, and both of which is connected parallel in the opposite polarity; a transformer for raising the voltage appearing across the diodes; a first rectifier for rectifying the raised AC into DC; a second rectifier for rectifying the current from the first line, when the first and second lines are disconnected due to the lamp-off, b) a voltage regulator, including a means for suppressing abnormal rise in the output voltage of the voltage supply, and c) a relay drive including a relay which is operated by DC voltage from the voltage supply, whereby the relay is a self-holding relay that once activated by the current flowing through the coil or winding, the relay remains the activated state even though the voltage is removed.

In the above, it is desirable that the means for suppressing abnormal rise in the output voltage of the voltage supply is a Zener diode.

In addition, one of the pair of diodes in the power supply includes two serial diodes respectively, and the first rectifier and the second rectifier are half-wave rectifier, respectively. The self-holding relay comprises two windings, one being for relay on, the other being for relay off.

The first rectifier of the power supply comprises a diode for rectifying the current flowing through a secondary of the transformer, a smoothing capacitor for smoothing the half-rectified current through the diode, and a Zener diode connected across the secondary of the transformer.

The second rectifier of the power supply comprises a capacitor connected to the first line, and a bridge diode connected to the capacitor. Or, the second rectifier comprises a diode, connected in the forward direction to the first line, for charging the capacitor, and a Zener diode connected in the forward direction to the second line.

### BRIEF DESCRIPTION OF THE DRAWINGS

The above and other features and advantages of the present invention will become more apparent by describing in detail exemplary embodiments thereof with reference to the attached drawings in which:

FIG. 1 and FIG. 2 are schematics showing conventional electronic switches,

FIG. 3 is a schematic showing the present invention,

FIG. 4 is a schematic of a power supply,

FIG. 5 is a schematic of a second rectifier and voltage regulator,

FIG. 6 is a schematic of a relay drive,

FIG. 7 is a schematic of the second embodiment of the second rectifier in FIG. 5,

FIG. 8 is a schematic of a primary side of a transformer according to the second embodiment of the power supply in FIG. 4,

FIG. 9 is a schematic of a secondary side of a transformer according to the second embodiment of the power supply in FIG. 4, and

FIG. 10 is a schematic of the second embodiment of the relay drive in FIG. 6.

### DETAILED DESCRIPTION OF THE INVENTION

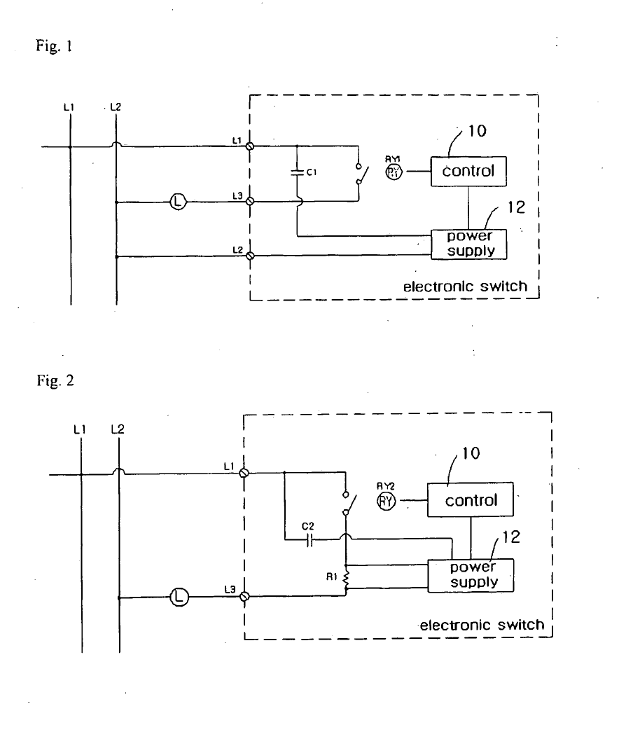

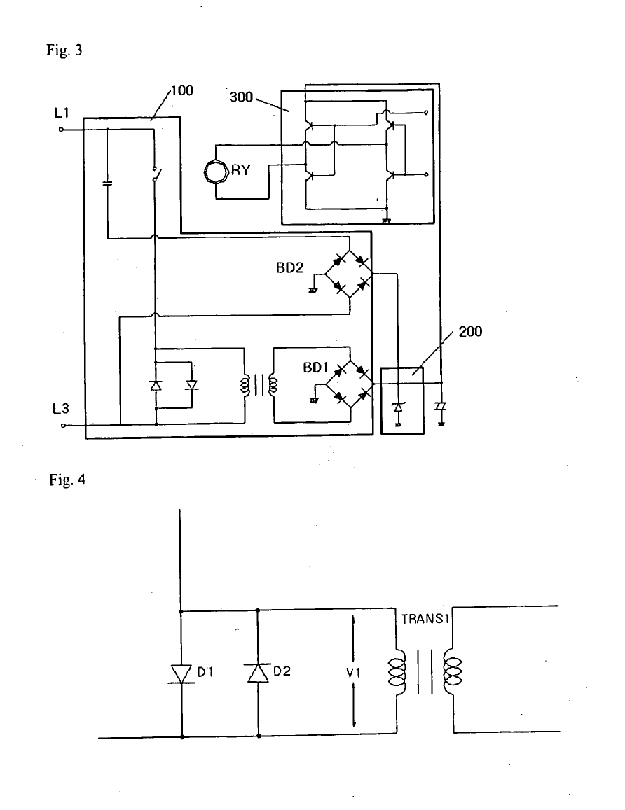

FIG. 3 shows an overall schematic of an electronic switch of the present invention. As shown, only two lines, L1 and L3, are utilized in the present invention. FIG. 3 denotes only the construction of an electronic switch as dotted in FIGS. 1 and 2. Since connection with external power lines and lamp related wirings are identical to those of FIGS. 1 and 2, description for these items will be omitted.

With reference to FIG. 3, the construction of the present invention will be described. The present invention is an electronic switch, having a first line and a second line connected across a lamp, for electronically turning the lamp on and off. The electronic switch is comprised of:

a power supply 100 including a pair of diodes D1, D2, each of which is inserted in series between the first and second lines L1, L3, and both of which is connected parallel in the opposite polarity; a transformer TRANS1 for raising the voltage appearing across the diodes; a first rectifier BD1 for rectifying the raised AC into DC; a second rectifier BD2 for rectifying the current from the first line L1, when the first and second lines L1, L2 are disconnected due to the lamp-off,

a voltage regulator 200, including a Zener diode, for suppressing abnormal rise in the output voltage of the voltage supply 100, and

a relay drive 300 including a relay RY which is operated by DC voltage from the voltage supply 100, whereby the relay is a self-holding relay that once activated by the current flowing the coil, the relay remains the activated state even though the voltage is removed.

From now, the constituents will be described in detail, with reference to various embodiments.

Construction and Operation of First Embodiment

<Power Supply 100>

As previously explained regarding FIG. 2, if a resistor is used to get electricity for turning a lamp on, instable electric energy may be obtained as the load of the lamp varies. However, in this embodiment of the present invention, as shown in FIG. 3, two diodes (see FIG. 4) are used instead of the resistor. Since the voltage drop across the diodes are constant as about 0.6V, relatively stable voltage can be obtained without impeding the AC current flow.

Voltage appears across the diodes is stepped up by the transformer, and is rectified by the rectifier circuit, good quality DC voltage for the relay drive 300 being obtained.

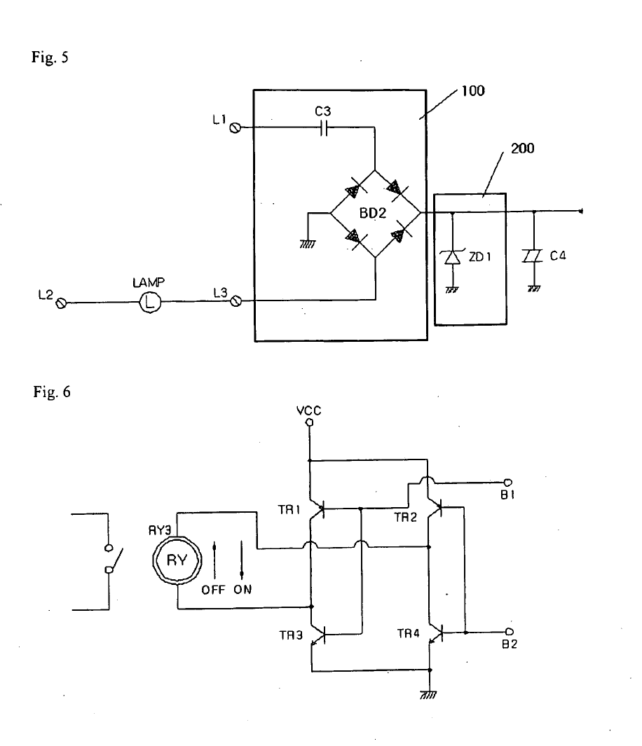

With reference to FIG. 5, when in lamp turned off, the electricity for the relay drive 300 is obtained through the path of L1, C3, the second rectifier BD2, L3, and a lamp. Since AC is used, as the direction of the current changes, the above path order will be also changed.

<Voltage Regulator 200>

In the present invention, a voltage regulator 200 is added. Like the right side of FIG. 5, it is comprised of a Zener diode ZD1. The Zener diode ZD1 prevents the abnormal rise in voltage, so that stable electric energy can be provided. <Relay Drive 300>

Though the present invention provides stable power source, if the load is significantly small, for example a 20 W fluorescent lamp, the sufficient current to drive a relay may not obtained.

To solve this problem, the present invention employs a self-holding, or a latch, type relay that, once activated by the current flowing a coil, the relay remains the activated state even though the voltage is removed. Therefore, unnecessary consumption of electricity can be reduced. In FIG. 6, to activate the relay RY3, a Low signal (0V) is applied to B2 for turning Tr2 on, and a High signal (5V) is applied to B1 for turning Tr3 on. Then, the current flows from VCC through Tr2, RY3, and Tr3 to the relay, and the relay is activated and the electric energy is supplied to a lamp. After a while, if a High (5V) is applied to B2 such that Tr2 is turned off, since the relay RY3 is a self-holding relay, it remains the connection state. To deactivate the relay, when a Low signal (0V) is applied to B1, Trn is turned on and the current flows from VCC through Tr1 to a relay coil, and also, when a High signal (5V) is applied to B2, the current flows through Tr4, and the relay contactors are disconnected.

Once the relay is deactivated, the relay remains this state though Tr1 and Tr4 are turned off. Like this, by using a self-holding type relay, small amount of power consumption is required and so capacity of power supply can be greatly reduced. Therefore, the electronic switch can be adapted to a circuit using a relatively small lamp.

Construction and Operation of Second Embodiment

<Rectifying when a Lamp is Turned Off>

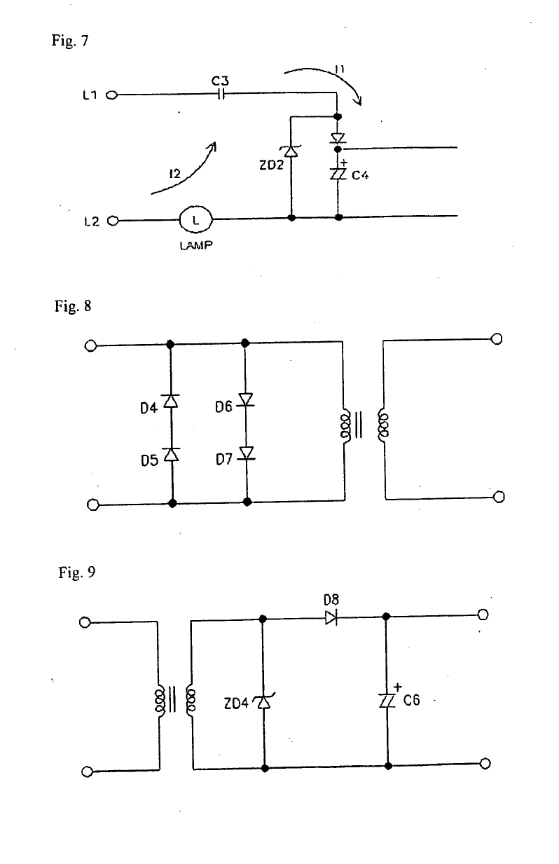

Returning to FIGS. 3 and 5, this first embodiment has shown a full-wave rectifier circuit BD2 having 4 diodes, which is a part of a power supply 100 and plays a role of full wave rectifying when the lamp is turned off. To reduce the number of diodes, as shown in FIG. 7, this second embodiment employs half-wave rectifier circuit for rectifying the current when the lamp is turned off. That is, the current I1 originated from L1 flows through a forward connected diode, charges a capacitor C4, and flows out of L2 after passing through a lamp L. On the other hand, the current I2 originated from L2 flows through a Zener diode ZD2 and a capacitor C3, without charging the capacitor C4. By doing so, although the amount of electricity may be decreased, the number of diodes can be reduced. This can give another economical advantage.

<Circuit for Obtaining Internal Voltage when a Lamp is Turned On and a Rectifier Used the Same>

FIG. 4 shows a primary side of a transformer, which is one element of those for internally obtaining the electricity when a lamp is turned on. It obtains the internal voltage by using two diodes D1 and D2. However, if the load is small, the voltage drop across the diodes becomes lower, and so the sufficient amount internal voltage cannot be obtained. To improve this problem, as shown in FIG. 8, two input diodes are added. That is, the existing diode D1 is increased into serial D4 and D5, and the existing diode D2 is increased into serial D6 and D7. By doing so, because the voltage drop between the lines increases, the sufficient internal voltage can be obtained.

The voltage obtained by such a circuit is rectified by a half-wave rectification circuit instead of the full-wave circuit BD1 in FIG. 3. This new rectifier is, see FIG. 9, composed of a rectifying diode D8, smoothing capacitor C6, and a Zener diode ZD4. The reason why this half-wave rectification is adapted is that the half-wave is enough to get voltage for internal operations when the load is sufficiently high, since if the load is large, the electric power got from the lines is also large.

<Relay Drive>

In the relay drive of the first embodiment shown in FIG. 6, four transistors were used. The respective transistors constituted the path of TR2, RY, and TR3 for relay on; TR1, RY, and TR4 for relay off. Here RY is a winding for a relay.

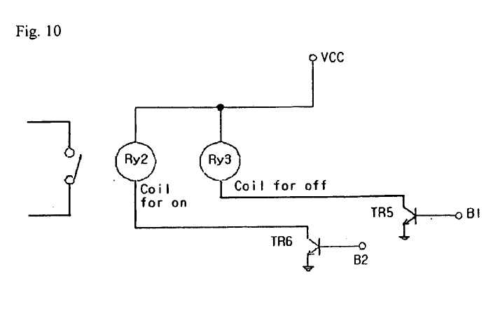

With reference to FIG. 10, the second embodiment to reduce the number of transistor, employs a self-holding relay similar to that of the first embodiment, but two separate windings are built in: one is for relay on (Ry2), the other is for off (Ry3).

If a control signal is applied to B2 (the base of TR6), Ry2 is energized and a relay is turned on. Conversely, if a control signal is applied to B1, Ry3 is energized and a relay is turned off. Therefore, the number of transistors is reduced in the second embodiment.

The advantages of the present invention are as follows.

1) Since there is no current required to holding a relay state, internal power consumption is very small. Therefore, a variety of lamps species can be used.

2) Since a transformer is used, the voltage drop at the power supply section is very low, and so table operation and less heat generation is secured.

3) This invention is basically 2-line based. So, replacement for existing switch is easy.

4) By using the voltage across the diodes instead of the resistor, variation in the load does not influence the voltage regularity.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An electronic switch for turning on an off a lamp, of which the both ends are connected between a first line and a second line, the electronic switch comprising:
a power supply including a pair of diodes, each of which is inserted in series between the first and second lines, and both of which is connected parallel in the opposite polarity; a transformer for raising the voltage appearing across the diodes; a first rectifier for rectifying the raised AC into DC; a second rectifier for rectifying the current from the first line, when the first and second lines are disconnected due to the lamp-off,
a voltage regulator, including a means for suppressing abnormal rise in the output voltage of the voltage supply, and
a relay drive including a relay which is operated by DC voltage from the voltage supply, whereby the relay is a self-holding relay that once activated by the current flowing the coil, the relay remains the activated state even though the voltage is removed.

2. The switch of claim 1, wherein the means for suppressing abnormal rise in the output voltage of the voltage supply is a Zener diode.

3. The switch of claim 1, wherein one of the pair of diodes in the power supply includes two serial diodes respectively.

4. The switch of claim 1, wherein the first rectifier and the second rectifier are half-wave rectifier, respectively.

5. The switch of claim 1, wherein the self-holding relay comprises two windings, one being for relay on, the other being for relay off.

6. The switch of claim 1, wherein the first rectifier of the power supply comprises
a diode for rectifying the current flowing through a secondary of the transformer,
a smoothing capacitor for smoothing the half-rectified current through the diode, and
a Zener diode connected across the secondary of the transformer.

8. The switch of claim 1, wherein the second rectifier of the power supply comprises a capacitor connected to the first line, and a bridge diode connected to the capacitor.

9. The switch of claim 1, wherein the second rectifier of the power supply comprises a diode, connected in the forward direction to the first line, for charging the capacitor, and a Zener diode connected in the forward direction to the second line.
